(19) United States
(12) Patent Application Publication
(10) Pub. No.: US 2015/0193989 A1
(43) Pub. Date: Jul. 9, 2015

(54) SYSTEM AND METHOD FOR DETERMINING UNAPPROVED DRIVING

(71) Applicants: Sascha Simon, Warwick, NY (US); Zvi Huber, Great Falls, VA (US)

(72) Inventors: Sascha Simon, Warwick, NY (US); Zvi Huber, Great Falls, VA (US)

(21) Appl. No.: 14/664,424

(22) Filed: Mar. 20, 2015

Related U.S. Application Data
(63) Continuation-in-part of application No. 14/105,934, filed on Dec. 13, 2013.
Application No. 14/105,934 is a continuation-in-part of application No. 14/105,744, filed on Dec. 13, 2013, now Pat. No. 8,989,952.
Application No. 14/105,744 is a continuation-in-part of application No. 14/095,156, filed on Dec. 3, 2013.
Application No. 14/095,156 is a continuation-in-part of application No. 14/072,231, filed on Nov. 5, 2013.
(60) Provisional application No. 61/745,677, filed on Dec. 24, 2012.
(60) Provisional application No. 61/740,851, filed on Dec. 21, 2012.
(60) Provisional application No. 61/740,831, filed on Dec. 21, 2012.
(60) Provisional application No. 61/740,814, filed on Dec. 21, 2012.
(60) Provisional application No. 62/033,290, filed on Aug. 5, 2014.
(60) Provisional application No. 62/033,284, filed on Aug. 5, 2014.
(60) Provisional application No. 62/033,278, filed on Aug. 5, 2014.
(60) Provisional application No. 61/955,995, filed on Mar. 20, 2014.

(51) Int. Cl. G07C 5/00

(52) U.S. Cl. CPC G07C 5/008

(57) ABSTRACT

A device is provided for use with a database having stored therein, a plurality of signatures corresponding to a plurality of instances, respectively. The device includes a vehicle mode determining component that determines whether the device is operating in a vehicle mode; a device location determining component that determines whether the device is located in a predetermined location; a parameter detecting component that detects a predetermined parameter and generates a parameter signature based on the detected predetermined parameter; an accessing component that accesses one of the plurality of signatures from the database; and an unapproved driving component that generates an unapproved driving signal based on the comparison signal when the vehicle mode determining component determines that the device is operating in the vehicle mode and when the location determining component determines that the device is located in the predetermined location.

The present application claims priority from: U.S. Provisional Application No. 61/740,814 filed Dec. 21, 2012; U.S. Provisional Application No. 61/740,831 filed Dec. 21, 2012; U.S. Provisional Application No. 61/740,851 filed Dec. 21, 2012; and U.S. Provisional Application No. 61/745,677 filed Dec. 24, 2012, U.S. Provisional Application No. 61/955,995 filed Mar. 20, 2014, U.S. Provisional Application No. 62/033,278 filed Aug. 5, 2014, U.S. Provisional Application No. 62/033,284 filed Aug. 5, 2014 and U.S. Provisional Application No. 62/033,290 filed Aug. 5, 2014, the entire disclosures of which are incorporated herein by reference. The present application is a continuation-in-part of U.S. application Ser. No. 14/072,231 filed Nov. 5, 2013, is a continuation-in-part of U.S. application Ser. No. 14/095,156 filed Dec. 3, 2013, is a continuation-in-par of U.S. application Ser. No. 14/105,744 filed Dec. 13, 2013, is a continuation-in-part of U.S. application Ser. No. 14/105,934 filed Dec. 13, 2013 and is a continuation-in-part of U.S. application Ser. No. 14/136,467 filed Dec. 20, 2013, the entire disclosures of which are incorporated herein by reference.

### BACKGROUND

Smartphones, tablets and other smart devices enable ever increasing functions and utility in all aspects of life. They are used throughout the day in many situations. Sometimes, smartphones, tablets and other smart devices are used for purposes at the wrong time and place. For example, users may text, talk or surf the internet on a smartphone, but such types of unapproved driving may compromise driving if performed while driving.

There are many other ways in which drivers may drive in an unapproved manner. For example, they may drive erratically when intoxicated or tired, increasing the chances of vehicle crashes. Further, they may drive at times or in places that are unauthorized.

What is needed is a system and method to monitor unapproved driving.

### SUMMARY

The present invention provides a system and method to detect unapproved driving of a user of a device when the device is near the driver seat location, when the device is in a vehicle mode and when the user is driving in a registered unapproved driving manner.

Various embodiments described herein are drawn to a device is provided for use with a database having stored therein, a plurality of signatures corresponding to a plurality of instances, respectively. The device includes a vehicle mode determining component operable to determine whether the device is operating in a vehicle mode: a device location determining component operable to determine whether the device is located in a predetermined location; a parameter detecting component operable to detect a predetermined parameter and to generate a parameter signature based on the detected predetermined parameter, an accessing component operable to access one of the plurality of signatures from the database; a comparing component operable to generate a comparison signal based on a comparison of the parameter signature and one of the plurality of signatures; and an unapproved driving component operable to generate an unapproved driving signal based on the comparison signal when the vehicle mode determining component determines that the device is operating in the vehicle mode and when the location determining component determines that the device is located in the predetermined location.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIGS. 1A-C illustrate the magnetic fields and vibrations associated with a vehicle as detected by a communication device located at three different locations within the vehicle, respectively, in accordance with aspects of the present invention;

FIGS. 2A-C illustrate a map;

FIG. 3 illustrates an example method of detecting unapproved driving via a communication device in accordance with aspects of the present invention;

FIG. 4 illustrates an example device in accordance with aspects of the present invention;

FIG. 5 illustrates an example method of registering a type of unapproved driving in accordance with aspects of the present invention;

FIG. 6 illustrates an example controlling component of the device of FIG. 4:

FIG. 7 illustrates an example parameter-detecting component of the device of FIG. 4;

FIG. 8 illustrates a method for detecting a type of unapproved driving when in a registered location while operating in a registered mode in accordance with aspects of the present invention;

FIG. 9 illustrates an example method of generating a signature associated with unapproved driving in accordance with aspects of the present invention; and

FIG. 10 illustrates an example method of verifying a type of unapproved driving in accordance with aspects of the present invention.

### DETAILED DESCRIPTION

Aspects of the present invention are drawn to a system and method for detecting unapproved driving via a communication device when the communication device is located near the driver seat and when the communication device is in a vehicle mode of operation and when the driver drives in an unapproved manner.

As used herein, the term “smartphone” includes cellular and/or satellite radiotelephone(s) with or without a display (text/graphical); Personal Communications System (PCS) terminal(s) that may combine a radiotelephone with data processing, facsimile and/or data communications capabilities; Personal Digital Assistant(s) (PDA) or other devices that can include a radio frequency transceiver and a pager, Internet/Intranet access, Web browser, organizer, calendar and/or a global positioning system (GPS) receiver; and/or conventional laptop (notebook) and/or palmtop (netbook) computer(s), tablet(s), or other appliance(s), which include a radio frequency transceiver. As used herein, the term “smartphone” also includes any other radiating user device that may have time-varying or fixed geographic coordinates and/or may be portable, transportable, wearable, installed in a vehicle (aeronautical, maritime, or land-based) and/or situated and/or configured to operate locally and/or in a distributed fashion over one or more location(s).

In one non-limiting example embodiment, a communication device, e.g., a smartphone: 1) automatically determines whether it is operating in a vehicle mode; 2) automatically determines whether it is in a predetermined location; and 3) detects unapproved driving when it determines that it is operating in the vehicle mode, when it determines that it is operating in the predetermined location and when the driver is driving in an unapproved manner.

In accordance with aspects of the present invention, a communication device may automatically determine whether it is operating in a vehicle mode by any known method. In accordance with aspects of the present invention, a communication device may automatically determine whether the communication device is in a predetermined location by any known method.

An unapproved manner of driving may take the form of erratic driving, aggressive driving, unsafe driving, driving under the influence of alcohol or drugs, driving in an unauthorized time, driving in an unauthorized place or combinations thereof.

For purposes of discussion, consider the situation where a person is driving a vehicle. If the driver were to text or talk on his phone while driving, the driver may compromise his driving, which would be an unapproved driving method. A communication device in accordance with the present invention may: 1) determine that it is in the driver's hand, thus indicating that the user of the phone is driving; 2) determine that the phone is in a vehicle mode, thus indicating that the phone is enable to detect parameters associated with the area within the vehicle; and 3) provide an signal that the driver is driving in an unapproved manner.

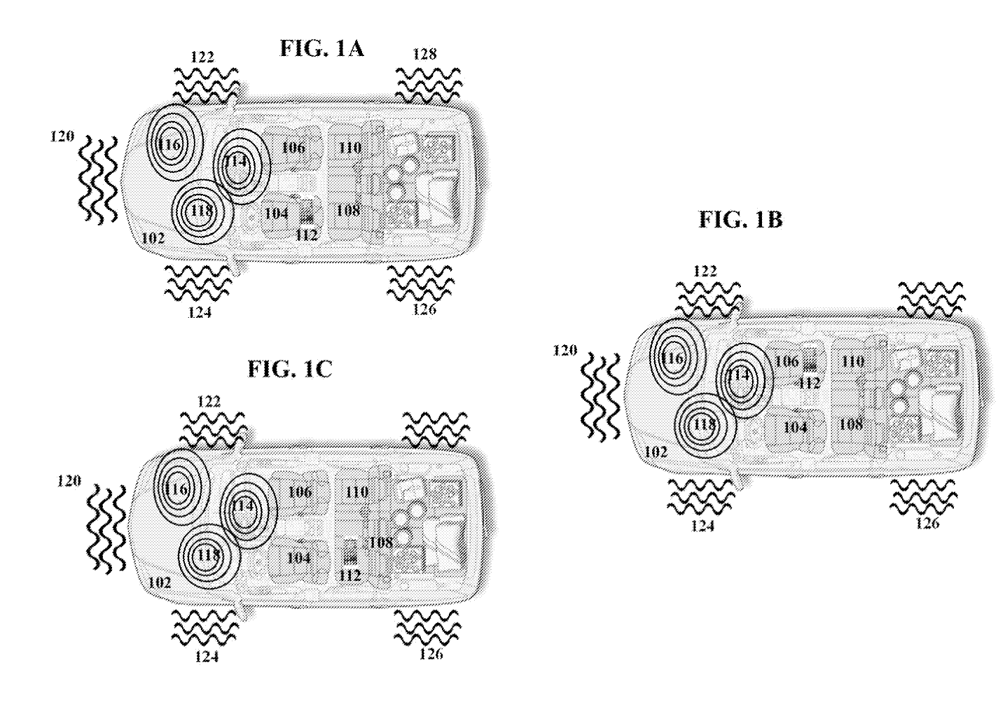

Aspects of the present invention will now be described with reference to FIGS. 1A-10.

FIGS. 1A-C illustrate the magnetic fields and vibrations associated with a vehicle as detected by a communication device located at three different locations within the vehicle, respectively, in accordance with aspects of the present invention.

As shown in FIG. 1A, a vehicle 102 includes a driver seat 104, a front passenger seat 106, a rear passenger seat 108 and a rear passenger seat 110. In this example, a person (not shown) is holding, or having in the immediate vicinity, a communication device 112, e.g., a smartphone, (not shown) in accordance with an aspect of the present invention, wherein the person is sitting in driver seat 104.

While running, electronic portions of vehicle 102 will generate magnetic fields, a sample of which is represented by field lines 114, 116 and 118. Further, the engine of vehicle 102 may generate vibrations represented by lines 120 and the tires rolling on the pavement will generate vibrations represented by lines 122, 124, 126 and 128.

As shown in FIG. 1B, the person (not shown) is holding, or having in the immediate vicinity, communication device 112, while sitting in passenger seat 106. As shown in FIG. 1C, the person (not shown) is holding communication device 112, while sitting in rear passenger seat 108.

In accordance with aspects of the present invention, communication device 112 may detect parameters within vehicle 102 to determine a more exact location of communication device 112. In this example embodiment, communication device 112 may detect the magnetic fields and the vibrations to determine the location of the user within vehicle 102. In accordance with another aspect of the present invention, this location determination may be used to operate communication device 112 in a particular mode, e.g., enabling predetermined features or functions associated with a specific location and/or disabling other predetermined features or functions associated with the specific location.

For example, the magnitude or vectors of the fields and vibrations as detected by communication device 112 when it is located in driver seat 104 may be compared with similar fields and vibrations associated with driver seat 104. Such a similarity in detected parameters may enable communication device 112 to determine that it is located near diver seat 104.

Further, the magnitude or vectors of the fields and vibrations as detected by communication device 112 when it is located in driver seat 104 as shown in FIG. 1A, may be distinguished from the magnitude or vectors of the fields and vibrations detected by communication device 112 when it is located in passenger seat 106 as shown in FIG. 1B, which may additionally be distinguished from the magnitude or vectors of the fields and vibrations detected by communication device 112 when it is located in rear passenger seat 108 as shown in FIG. 1C.

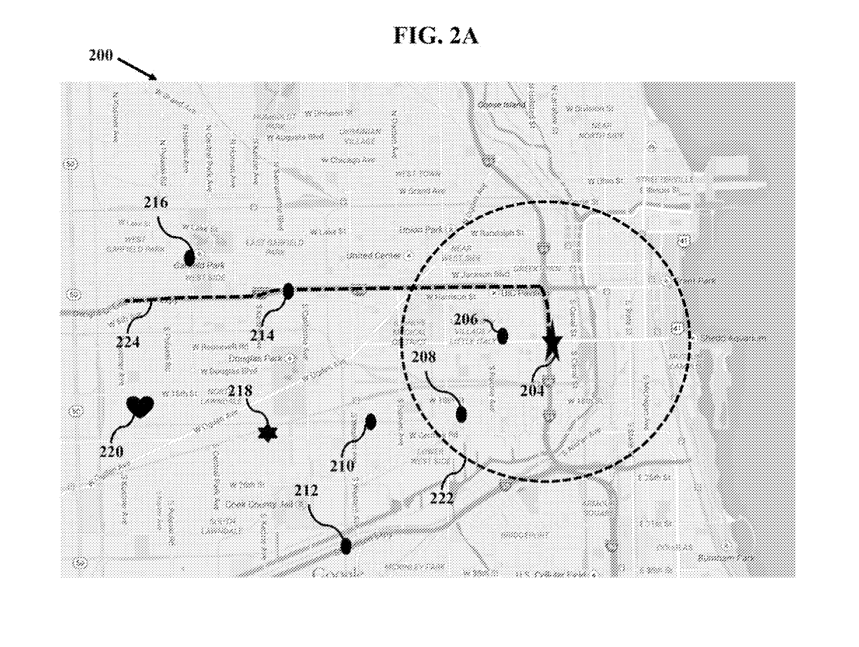

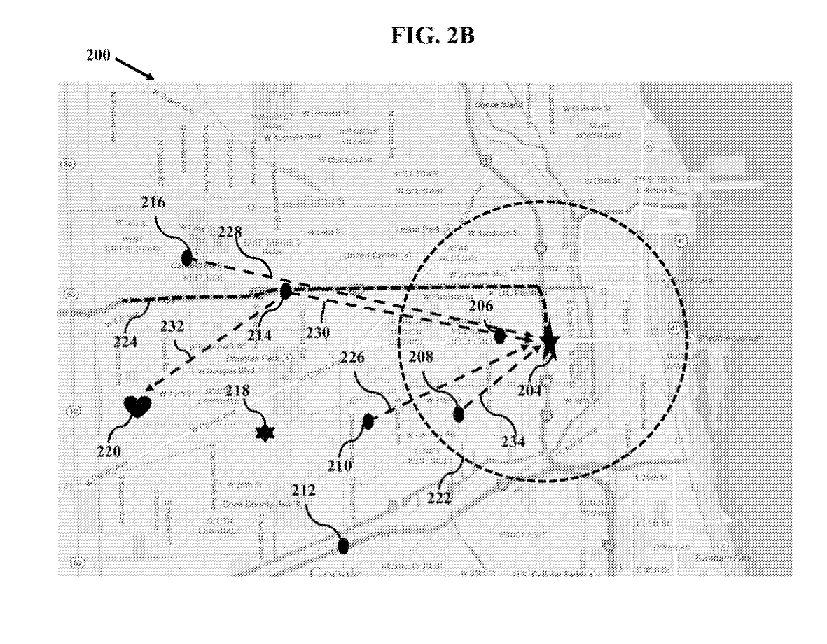

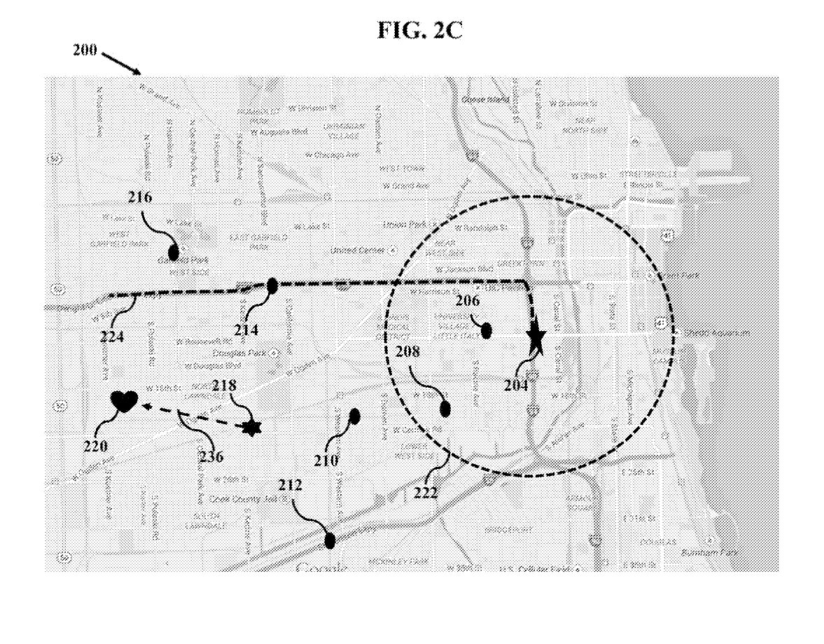

The in-vehicle location determination discussed above with reference to FIG. 1A-C is but one example implementation in accordance with aspects of the present invention. Other non-liming example implementations include determining whether the communication device is located in specific locations, which will now be further described with reference to FIGS. 2-5.

FIGS. 2A-C illustrate a map 200 of an urban area.

As shown in the figures, map 200 includes a dispatcher 204, a driver 206, a driver 208, a driver 210, a driver 212, a driver 214, a driver 216, a driver 218, a person 220, a zone 222 and a route 224.

In this example dispatcher 204 is located at a headquarters of a company, which employs drivers 206, 208, 210, 212, 214 and 216. Further, for purposes of this discussion, presume the following stipulations: 1) let driver 214 be the father of driver 218, and let person 220 be the wife of driver 214 and the mother of driver 218; 2) let drivers 206, 208 and 210 be tasked by dispatcher 204 to drive only to destinations within zone 222; and 3) let drivers 214 and 216 be tasked by dispatcher 204 to drive only along route 224.

It is clear from FIG. 2A that driver 210 is not driving in accordance with the task from dispatcher 204, as driver 210 is driving outside of zone 222. Accordingly, driver 210 is engaged in unapproved driving. Similarly, it clear that driver 216 is not driving in accordance with the task from dispatcher 204, as driver 216 is not driving on route 224. Accordingly, driver 216 is additionally engaged in unapproved driving.

As shown in FIG. 2B, in accordance with aspects of the present invention, a communication device of driver 210 may provide an unapproved driving signal 226 to dispatcher 204 of the unapproved driving of driver 210. Similarly, in accordance with aspects of the present invention, a communication device of driver 216 may provide an unapproved driving signal 228 to dispatcher 204 of the unapproved driving of driver 216.

Further, presume that driver 214 is fighting sleep while driving along route 224. Predetermined detectable parameters may be indicative a person fighting sleep while driving. In this example, driving while fighting sleep is unapproved driving. In accordance with aspects of the present invention, a communication device of driver 214 may detect that driver 214 is fighting sleep while driving and provide an unapproved driving signal 230 to dispatcher 204 of the unapproved driving of driver 214. An unapproved driving signal might not only go to a single receiver. For example, in accordance with aspects of the present invention, the communication device of driver 214 may additionally provide an unapproved driving signal 232 to his wife, person 220, of the unapproved driving of driver 214. In particular, his wife would want warnings as to when her husband is in danger of having an accident.

Still further, presume that driver 208 is unacceptably aggressively driving within zone 208. Predetermined detectable parameters may be indicative a person unacceptably aggressive driving. In this example, unacceptably aggressive driving is unapproved driving. In accordance with aspects of the present invention, a communication device of driver 208 may detect that driver 208 is unacceptably aggressive driving and provide an unapproved driving signal 234 to dispatcher 204 of the unapproved driving of driver 208.

As mentioned above with reference to driver 214, aspects of the present invention extend beyond commercial embodiments, wherein a fleet of commercial drivers are monitored by a dispatcher. On the contrary, aspects of the present invention may also be used on a personal level. For example, presume that driver 218 is unacceptably driving after a curfew imposed by his mother, person 220. Predetermined detectable parameters may be indicative a person driving outside of a curfew. In this example, driving outside of a curfew is unapproved driving. As shown in FIG. 2C, in accordance with aspects of the present invention, a communication device of driver 218 may detect that driver 218 is unacceptably driving outside of the curfew and provide an unapproved driving signal 236 to person 220 of the unapproved driving of driver 218.

In accordance with another aspect of the present invention, a communication device may provide a warning to the user of the device upon detection of unapproved driving. For example, if driver 214 is fighting sleep while driving, the communication device of driver 214 may provide an audible warning to driver 214. Upon receiving the warning, driver 214 may take appropriate measures, such as pulling over and resting.

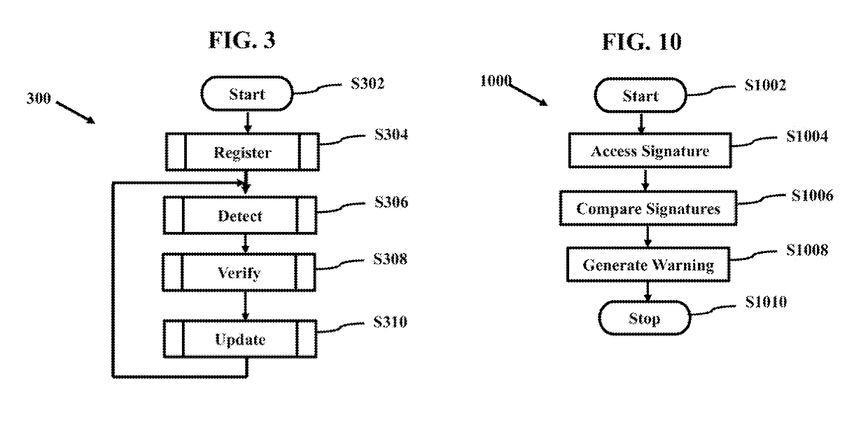

A more detailed discussion of example working embodiment will now be discussed with additional reference to FIGS. 3-10.

FIG. 3 illustrates an example method 300 of detecting unapproved driving via a communication device in accordance with aspects of the present invention.

Method 300 starts (S302) and a location, a mode and a type of unapproved driving are registered (S304).

As for registration of a location, for example, returning to FIG. 1A, if a person would like to be able to identify the position of driver seat 104 within vehicle 102, the position of driver seat 104 would be registered based on detectable parameters associated with driver seat 104. Similarly, returning to FIG. 1B, if a person would like to be able to identify the position of passenger seat 106 within vehicle 102, the position of passenger seat 106 would be registered based on detectable parameters associated with passenger seat 106.

As for registration of a mode, for example, returning to FIG. 1A, a user may register a vehicle mode associated with the registered location of driver seat 104.

As for registration of a type of unapproved driving, for example, returning to FIG. 1A, a user may register the act of driving outside of a curfew.

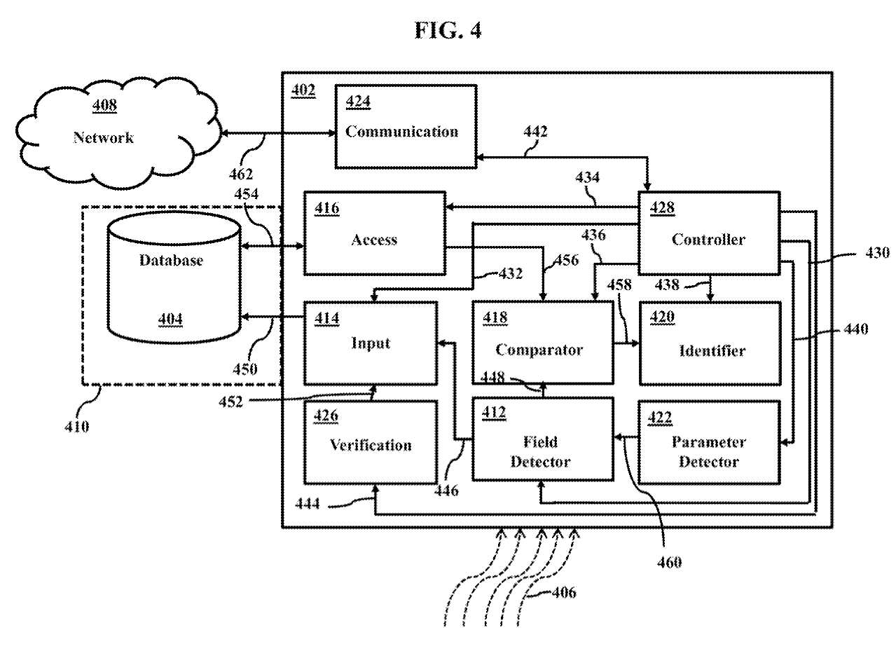

A more detailed discussion of registration of a location, a mode and a type of unapproved driving will now be provided with additional reference to FIGS. 4-10.

FIG. 4 illustrates an example device 402 in accordance with aspects of the present invention.

FIG. 4 includes a device 402, a database 404, a field 406 and a network 408. In this example embodiment, device 402 and database 404 are distinct elements. However, in some embodiments, device 402 and database 404 may be a unitary device as indicated by dotted line 410.

Device 402 includes a field-detecting component 412, an input component 414, an accessing component 416, a comparing component 418, an identifying component 420, a parameter-detecting component 422, a communication component 424, a verification component 426 and a controlling component 428.

In this example, field-detecting component 412, input component 414, accessing component 416, comparing component 418, identifying component 420, parameter-detecting component 422, communication component 424, verification component 426 and controlling component 428 are illustrated as individual devices. However, in some embodiments, at least two of field-detecting component 412, input component 414, accessing component 416, comparing component 418, identifying component 420, parameter-detecting component 422, communication component 424, verification component 426 and controlling component 428 may be combined as a unitary device. Further, in some embodiments, at least one of field-detecting component 412, input component 414, accessing component 416, comparing component 418, identifying component 420, parameter-detecting component 422, communication component 424, verification component 426 and controlling component 428 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Controlling component 428 is arranged to communicate with: field-detecting component 412 via a communication line 430; input component 414 via a communication line 432; accessing component 416 via a communication line 434; comparing component 418 via a communication line 436; identifying component 420 via a communication line 438; parameter-detecting component 422 via a communication line 440; communication component 424 via a communication line 442; and verification component 426 via a communication line 444. Controlling component 428 is operable to control each of field-detecting component 412, input component 414, accessing component 416, comparing component 418, identifying component 420, parameter-detecting component 422, communication component 424 and verification component 426.

Field-detecting component 412 is additionally arranged to detect field 406, to communicate with input component 414 via a communication line 446, to communicate with comparing component 418 via a communication line 448 and to communicate with parameter-detecting component 422 via a communication line 445. Field-detecting component 412 may be any known device or system that is operable to detect a field, non-limiting examples of which include an electric field, a magnetic field, and electro-magnetic field and combinations thereof. In some non-limiting example embodiments, field-detecting component 412 may detect the amplitude of a field at an instant of time. In some non-limiting example embodiments, field-detecting component 412 may detect a field vector at an instant of time. In some non-limiting example embodiments, field-detecting component 412 may detect the amplitude of a field as a function over a period of time. In some non-limiting example embodiments, field-detecting component 412 may detect a field vector as a function over a period of time. In some non-limiting example embodiments, field-detecting component 412 may detect a change in the amplitude of a field as a function over a period of time. In some non-limiting example embodiments, field-detecting component 412 may detect a change in a field vector as a function over a period of time. Field-detecting component 412 may output a signal based on the detected field.

Input component 414 is additionally arranged to communicate with database 404 via a communication line 450 and to communicate with verification component 426 via a communication line 452. Input component 414 may be any known device or system that is operable to input data into database 404. Non-limiting examples of input component 414 include a graphic user interface (GUI) having a user interactive touch screen or keypad.

Accessing component 416 is additionally arranged to communicate with database 404 via a communication line 454 and to communicate with comparing component 418 via a communication line 456. Accessing component 416 may be any known device or system that access data from database 404.

Comparing component 418 is additionally arranged to communicate with identifying component 420 via a communication line 458. Comparing component 418 may be any known device or system that is operable to compare two inputs.

Parameter-detecting component 422 is additionally arranged to communicate with identifying component 422 via a communication line 460. Parameter-detecting component 422 may be any known device or system that is operable to detect a parameter, non-limiting examples of which include velocity, acceleration, angular velocity, angular acceleration, geodetic position, light, sound, temperature, vibrations, pressure, biometrics, contents of surrounding atmosphere and combinations thereof. In some non-limiting example embodiments, parameter-detecting component 422 may detect the amplitude of a parameter at an instant of time. In some non-limiting example embodiments, parameter-detecting component 422 may detect a parameter vector at an instant of time. In some non-limiting example embodiments, parameter-detecting component 422 may detect the amplitude of a parameter as a function over a period of time. In some non-limiting example embodiments, parameter-detecting component 422 may detect a parameter vector as a function over a period of time. In some non-limiting example embodiments, parameter-detecting component 422 may detect a change in the amplitude of a parameter as a function over a period of time. In some non-limiting example embodiments, parameter-detecting component 422 may detect a change in a parameter vector as a function over a period of time.

Communication component 424 is additionally arranged to communicate with network 408 via a communication line 462. Communication component 424 may be any known device or system that is operable to communicate with network 408. Non-limiting examples of communication component include a wired and a wireless transmitter/receiver.

Verification component 426 may be any known device or system that is operable to provide a request for verification. Non-limiting examples of verification component 426 include a graphic user interface having a user interactive touch screen or keypad.

Communication lines 430, 432, 434, 436, 438, 440, 442, 444, 445, 446, 448, 450, 452, 454, 456, 458, 460 and 462 may be any known wired or wireless communication line.

Database 404 may be any known device or system that is operable to receive, store, organize and provide (upon a request) data, wherein the “database” refers to the data itself and supporting data structures. Non-limiting examples of database 404 include a memory hard-drive and a semiconductor memory.

Network 408 may be any known linkage of two or more communication devices. Non-limiting examples of database 408 include a wide-area network, a local-area network and the Internet.

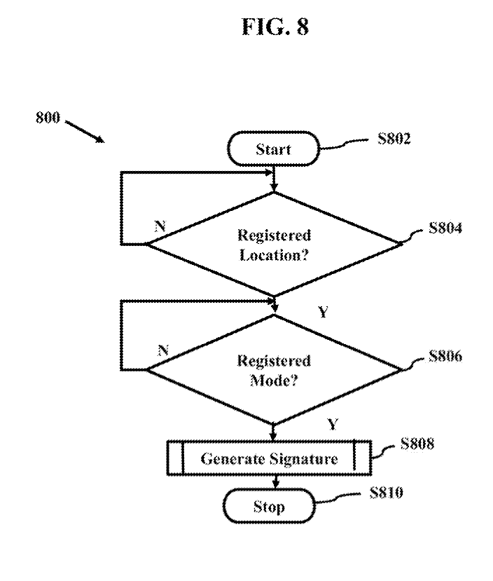

In accordance with aspects of the present invention, device 402 provides a signal indicative of unapproved driving, when it is in a predetermined location, when it is in a predetermined mode and when certain parameters are detected that are indicative of unapproved driving. These aspects will be further described with additional reference to FIGS. 8-10.

For purposes of discussion, consider the following example where a person is driving outside of curfew, while device 402 is the position of driver seat 104 within vehicle 102 and while device 402 is in a vehicle mode.

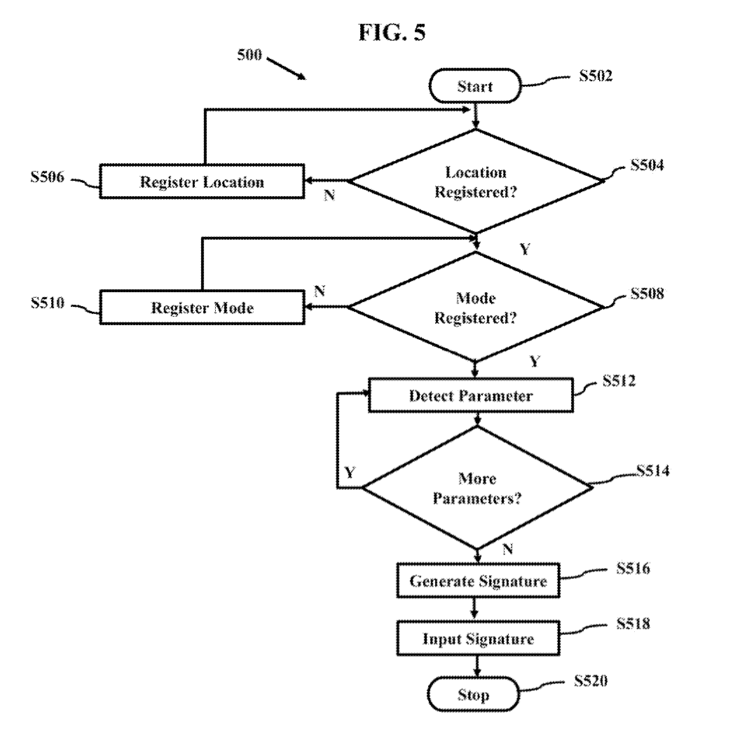

FIG. 5 illustrates an example method 500 of registering a type of unapproved driving in accordance with aspects of the present invention.

As shown in the figure, method 500 starts (S502) and it is determined whether the current location is registered (S504). For example, detected parameters of the current location may be used to generate a location signature associated with the current location. This type of location signature generation may be performed by any known method, a non-limiting example of which is disclosed in U.S. patent application Ser. No. 14/072,231. As shown in FIG. 4, the location signature for the current location may be stored in database 404. Databased 404 may have a plurality of location signatures for a plurality of locations, each of which may have been supplied to database 404 as a priori information.

Returning to FIG. 5, if it is determined that the current location is not registered (N at S504), then the location is registered (S506). For example, returning to FIG. 4, controlling component 428 may register the current location.

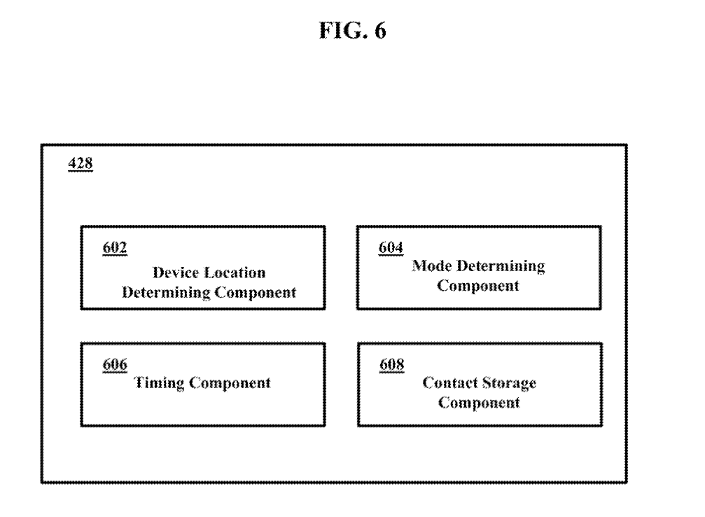

FIG. 6 illustrates an example controlling component 428.

As shown in the figure, controlling component 428 includes a device location determining component 602, a mode determining component 604, a timing component 606 and a contact storage component 608.

In this example, device location determining component 602, mode determining component 604, timing component 606 and contact storage component 608 are illustrated as individual devices. However, in some embodiments, at least one of device location determining component 602, mode determining component 604, timing component 606 and contact storage component 608 may be combined as a unitary device. Further, in some embodiments, at least one of device location determining component 602, mode determining component 604, timing component 606 and contact storage component 608 may be implemented as a computer having tangible computer-readable media for carrying or having computer-executable instructions or data structures stored thereon.

Device location determining component 602 may be any device or system that is able to determine whether device 402 is in a predetermined location. Mode determining component 604 may be any device or system that is able to determine whether device 402 is in a predetermined mode. Timing component 606 may be any device or system that is able to control timing parameters and retain timing thresholds. Contact storage component 608 may be any device or system that is able to store contact information.

One non-limiting example of device location determining component 602 being able to register the current location includes the situation when a user instructs device 402 to register the current location by way of input component 414. For example, a user may activate an icon on the GUI to indicate that device 402 is now in a vehicle. Such activation of the GUI would inform device location determining component 602 that device 402 is in a predetermined location.

Another non-limiting example of device location determining component 602 being able to register the current location includes detecting a field by way of field-detecting component 412. For example, returning to FIG. 4, field-detecting component 412 detects field 406. For purposes of discussion, let field 406 be a magnetic field corresponding to the superposition of magnetic fields generated by all electronic and mechanical systems involved with the running vehicle, e.g., magnetic fields 114, 116 and 118 as shown in FIG. 1A. A detected field signature may be compared with a priori field signature by any known manner, a non-limiting example of which includes that as described in U.S. patent application Ser. No. 14/072,231.

Another non-limiting example of device location determining component 602 being able to register the current location includes detecting other parameters by way of parameter-detecting component 422. These other detected parameters may be used to generate a location signature, which in turn will be compared with a priori location signatures by any known manner, a non-limiting example of which includes that as described in U.S. patent application Ser. No. 14/072,231.

In some embodiments, device 402 has a predetermined number of parameters to detect, wherein controlling component 428 may control such detections. For example, the first parameter to be detected may be a magnetic field associated with a running vehicle, wherein controlling component 428 may instruct field-detecting component 412 to detect a magnetic field. Further, a second parameter to be detected may be another known detected parameter additionally associated with the running vehicle, e.g., vibrations in the chassis, wherein controlling component 428 may instruct parameter-detecting component 422 to detect the second parameter. Further parameter-detecting component 422 may be able to detect many parameters.

For example, detected parameters of the current location may be used to generate a location signature associated with the current location. This type of location signature generation may be performed by any known method, a non-limiting example of which is disclosed in U.S. patent application Ser. No. 14/072,231, wherein device location determining component 602 may control field-detecting component 412, parameter-detecting component 422, comparing component 418 and input component 414 to generate and store a location signature of the current location into database 404.

At this point, in this example, the location of the driver's seat in the vehicle of the user of device 402 is registered. As such, device 402 will now automatically recognize when it is in the location of the driver's seat in the vehicle of the user of device 402.

The above discussed embodiment described recognizing when device 402 is located near the driver seat of a vehicle. However, in other embodiments, device 402 may be located in other locations within the vehicle. Clearly there may be situations where it is important to distinguish between a driver location and a passenger location. For example, a communication device of a commuter bus driver may need to be monitored in a manner different from a communication device of a passenger of the commuter bus. However, there may be situation where it is less important to distinguish between a driver location and some other location within the vehicle. For example, a communication device of a delivery driver, who will be transporting other passengers, may be placed in other locations with the vehicle. In such cases, the registered location may be any location within the vehicle.

Returning to FIG. 5, now that the current location is registered (S506 then returns to S504), it is determined whether the current mode is registered (S508). For example, returning to FIG. 4, controlling component 428 may determine whether the current mode is registered. In some embodiments, device 402 may have specific preset modes, such as a vehicle mode.

Returning to FIG. 5, if it is determined that the current mode is not registered (N at S508), then the mode is registered (S10). For example, returning to FIG. 4, mode determining component 604 of controlling component 428 may register the current mode. In some embodiments, device 402 may enable a user to establish modes, such as a vehicle mode. In an example embodiment, the user may use the GUI to establish a mode by assigning a specific mode to the current location.

Once the operating mode of 402 is determined, controller 428 determines whether the detected mode coincides with the registered location. For example, a user would not want device 402 in a registered and detected location of a driver seat 104, as shown in FIG. 1, to operate in other than a vehicle mode.

Returning to FIG. 5, in this example embodiment, the mode is registered (S510) after the location is registered (S504). However, in some embodiments, the mode may be registered prior to the location being registered. Further, in some embodiments, the mode may be registered concurrently with the location being registered.

After the mode is registered (S510), in this example, a parameter is detected (S512) in order to register a signature for unapproved driving—a driving signature. For example, returning to FIG. 4, let the parameter be orientation of device 402 when the user is texting, wherein parameter-detecting component 422 detects orientation of device 402. Other parameters may be used that are indicative of texting while driving, which would be unapproved driving. Further, there are a number of detectable parameters that are indicative of a number of other types of unapproved driving, e.g.: rapid cycles of acceleration and deceleration, as detected by accelerometers, may be indicative of aggressive driving; repeated swerving onto rumble strips, as detected by vibration sensors, may be indicative of a driving fighting sleep; driving in an unauthorized area, as detected by a global positioning system (GPS), may be indicative of unauthorized driving; driving at an unauthorized time, as measured by a clock, may be indicative of unauthorized driving: detecting repeated changes of a radio station, as detected by a microphone, may be indicative of a driving fighting sleep. These are all merely non-limiting examples of unauthorized driving, wherein any driving method may be detected so long as a detected parameter is associated therewith.

The detected parameter may be any known detectable parameter, of which non-limiting examples include electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

Returning to FIG. 5, after the first parameter is detected (S512), it is determined whether another parameter is to be detected (S514). For example, returning to FIG. 4, controlling component 428 may instruct at least one of field-detecting component 412 and parameter-detecting component 422 to detect another parameter.

A magnetic field may be a relatively distinct parameter that may be used to determine whether the driver is driving in an unapproved manner—that is that the driving is texting while driving. However, there may be situations that elicit a false positive, e.g., the driver has placed device 402 in a holder that has the same position as if the driver where holding device 402 while texting. As such, in order to reduce the probability of a false positive unapproved driving signal that device 402 is in a specific orientation, a second parameter associated with the type of unapproved driving may be used. Along this notion, it is an example aspect of the invention to detect a plurality of parameters associated with a type of unapproved driving to increase the probability of a correct identification of the type of unapproved driving.

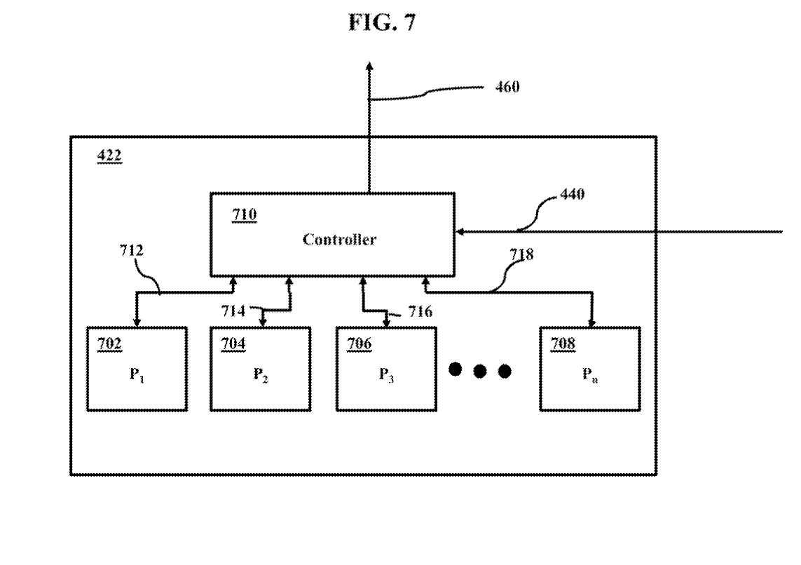

In some embodiments, device 402 has a predetermined number of parameters to detect, wherein controlling component 428 may control such detections. For example, the first parameter to be detected (in S512) may be orientation, wherein controlling component 428 may instruct parameter-detecting component 422 to detect orientation. Further, a second parameter to be detected may be another known detected parameter additionally associated with texting, e.g., acceleration associated with button pushing, wherein controlling component 428 may instruct parameter-detecting component 422 to detect the second parameter. Further parameter-detecting component 422 may be able to detect many parameters. This will be described with greater detail with reference to FIG. 7.

FIG. 7 illustrates an example parameter-detecting component 422.

As shown in the figure, parameter-detecting component 422 includes a plurality of detecting components, a sample of which are indicated as a first detecting component 702, a second detecting component 704, a third detecting component 706 and an n-th detecting component 708. Parameter-detecting component 422 additionally includes a controlling component 710.

In this example, detecting component 702, detecting component 704, detecting component 706, detecting component 708 and controlling component 710 are illustrated as individual devices. However, in some embodiments, at least two of detecting component 702, detecting component 704, detecting component 706, detecting component 708 and controlling component 710 may be combined as a unitary device. Further, in some embodiments, at least one of detecting component 702, detecting component 704, detecting component 706, detecting component 708 and controlling component 710 may be implemented as a computer having tangible computer-readable media for carrying or having computer-executable instructions or data structures stored thereon.

Controlling component 710 is configured to communicate with: detecting component 702 via a communication line 1012; detecting component 704 via a communication line 1014; detecting component 706 via a communication line 1016; and detecting component 708 via a communication line 1018. Controlling component 710 is operable to control each of detecting component 702, detecting component 704, detecting component 706 and detecting component 708. Controlling component 710 is additionally configured to communicate with controlling component 428 of FIG. 4 via communication line 440 and to communicate with field-detecting component 412 of FIG. 4 via communication line 460.

The detecting components may each be a known detecting component that is able to detect a known parameter. For example each detecting component may be a known type of detector that is able to detect at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof. For purposes of discussion, let: detecting component 702 be able to detect sound; detecting component 704 be able to detect velocity in three dimensions, detecting component 706 be able to detect vibrations: and detecting component 708 be able to detect geodetic position.

In some non-limiting example embodiments, at least one of the detecting components of parameter-detecting component 422 may detect a respective parameter as an amplitude at an instant of time. In some non-limiting example embodiments, at least one of the detecting components of parameter-detecting component 422 may detect a respective parameter as a function over a period of time.

Each of the detecting components of parameter-detecting component 422 is able to generate a respective detected signal based on the detected parameter. Each of these detected signals may be provided to controlling component 710 via a respective communication line.

Controlling component 710 is able to be controlled by controlling component 428 via communication line 440.

Returning to FIG. 5, if another parameter is to be detected (Y at S514), then another parameter will be detected (S512). For example, as shown in FIG. 4, controlling component 428 may then instruct parameter-detecting component 422 to detect another parameter via communication line 440. For purposes of discussion, let the second parameter to be detected be acceleration. As such, at this point, as shown in FIG. 4, controlling component 710 instructs detecting component 702, via communication line 1012, to detect acceleration. Detecting component 702 provides a signal corresponding to the detected acceleration to controlling component 710 via communication line 1012.

This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive type of unapproved driving identification.

Retuning to FIG. 7, as just discussed, controlling component 710 is able to send individual detected signals from each detecting component. In other example embodiments, controlling component 710 is able to receive and hold the individual detected signals from each detecting component, wherein controlling component 710 is able to generate a composite detected signal that is based on the individual detected signals. The composite detected signal may be based on any of the individual detected signal, and combinations thereof. In some embodiments, controlling component 710 may additionally process any of the individual detected signals and combinations thereof to generate the composite detected signal. Non-limiting examples of further processes include averaging, adding, subtracting, and transforming any of the individual detected signals and combinations thereof.

It should be further noted that in some embodiments, all parameters that are to be detected are detected simultaneously. In such a case, for example, as shown in FIG. 4, controlling component 428 may then instruct parameter-detecting component 422 to detect all parameters via communication line 440. As such, at this point, as shown in FIG. 7, controlling component 710 instructs all the detecting components to detect their respective parameters. All the detecting components then provide a respective signal corresponding to the respective detected parameter to controlling component 710 via communication line 1014. In this example, controlling component 710 may then provide the detected signal to field-detecting component 412 via communication line 460 as shown in FIG. 4.

Returning to FIG. 5, if no more parameters are to be detected (N at S514), then a driving signature is generated (S516). For example as shown in FIG. 4, parameter-detecting component 422 may generate a driving signature of the type of unapproved driving based on the detected parameter.

Returning to FIG. 5, once the driving signature is generated (S516), the driving signature in input into memory (S518). For example, as shown in FIG. 4, field-detecting component 412 provides the signature to input component 414 via communication line 446.

In an example embodiment, input component 414 includes a GUI that informs a user of device 402 that a driving signature has been generated. Input component 414 may additionally enable the user to input an association between the registered location, the registered mode and the generated driving signature. For example, input component 414 may display on a GUI a message such as “A signature was generated. To what type of unapproved driving is the signature associated?” Input component 414 may then display an input prompt for the user to input, via the GUI, a type of unapproved driving to be associated with the generated driving signature.

Input component 414 may then provide the driving signature, and the association to a specific location and mode, to database 404 via communication line 450.

As discussed above, in some embodiments, database 404 is part of device 402, whereas in other embodiments, database 404 is separate from device 402. Data input and retrieval from database 404 may be faster when database 404 part of device 402, as opposed to cases where database 404 is distinct from device 402. However, size may be a concern when designing device 402, particularly when device 402 is intended to be a handheld device such as a smartphone. As such, device 402 may be much smaller when database 404 is distinct from device 402, as opposed to cases where database 404 is part of device 402.

Consider an example embodiment, where database 404 is part of device 402. In such cases, input component 414 may enable a user to input driving signatures and the location/mode associations, for a predetermined number of types of unapproved driving. In this manner, database 404 will only be used for device 402.

Now consider an example embodiment, where database 404 is separate from device 402. Further, let database 404 be much larger than the case where database 404 is part of device 402. Still further, let database 404 be accessible to other devices in accordance with aspects of the present invention. In such cases, input component 414 may enable a user to input driving signatures and the location/mode associations, for a much larger predetermined number of types of unapproved driving. Further, in such cases, input component 414 may enable other users of similar devices to input driving signatures and the location/mode associations, for even more types of unapproved driving.

It should be noted that although the above-discussed example includes identifying texting as a type of unapproved driving, this is a non-limiting example. Aspects of the invention may additionally be used to identify any type of unapproved driving that has detectable parameters.

In some embodiments, a parameter (or multiple parameters) may be detected over a period of time. For example, detections of vibrations associated with driving over rumble strips may be indicative of driving while fighting sleep. However, this may be detected if a driver repeatedly swerves onto the rumble strips within a predetermined time frame. Similarly, changing the radio station or changing the volume of the radio may be indicative of driving while fighting sleep. However, this may be detected if a driver repeatedly changes the radio station or changes the volume of the radio within a predetermined time frame.

Accordingly, in some embodiments, as shown in FIG. 6, timing component 606 of controlling component 428 may have time thresholds stored therein. Presume that a detecting component within parameter-detecting component 422 were to detect a parameter associated with unapproved driving at a first time, t₁. Then, presume that the detecting component within parameter-detecting component 422 were to detect the parameter associated with the unapproved driving at a second time, t₂. In some embodiments, the driving signature may be generated when the difference between t₂ and t₁ is less than the time threshold within timing component 606. In other embodiments, the driving signature may be generated when the detecting component within parameter-detecting component 422 were to detect a parameter associated with unapproved driving a predetermined number of times within a time threshold.

At this point, method 500 stops (S520).

A location, a mode of operation at the registered location, and a type of unapproved driving have been registered. In accordance with aspects of the present invention, device 402 will be able to subsequently automatically determine when it is in the registered mode at the registered location. When device 402 automatically determines such situations, device 402 will automatically detect registered types of unapproved driving.

Returning to FIG. 3, now that a location, a mode and a type of unapproved driving have been registered (S304), a type of unapproved driving may be detected (S306). In other words, now that a location has been registered, and now that a mode of operation of device 402, at the location, has been registered, device 402 will detect whether it is in the registered location while operating in the registered mode and a predetermined type of unapproved driving is detected. This will further described with additional reference to FIG. 8.

FIG. 8 illustrates a method 800 for detecting a type of unapproved driving when in a registered location while operating in a registered mode.

As shown in the figure, method 800 starts (S802) and it is determined whether the current location is a registered location (S804). The current location may be detected by any known system or method. In an example embodiment, the location is detected in a manner as disclosed in U.S. patent application Ser. No. 14/105,934.

For example, returning to FIG. 4, a plurality of parameters may be detected via field-detecting component 412 and parameter-detecting component 422. The detected parameters may be used to generate a location signature of the current location. The generated location signature is then compared with previously stored location signatures associated with previously registered locations, as stored in database 404. When the generated location signature coincides with a previously stored location signature associated with previously registered location, identifying portion 420 identifies the current location as one of the previously registered locations.

If device 402 is not in a registered location (N at S804), then method 800 continues until it is determined that device 402 is in a registered location (Y at S804).

Returning to FIG. 8, after determining that the current location is a registered location (Y at S804), it is determined whether the current mode of operation is a registered mode corresponding to the registered location (S806). The current mode may be detected in a manner similar to that discussed above with reference to FIG. 5 (S508). In particular, for example, returning to FIG. 4, controlling component 428 may determine whether the current mode is registered. In some embodiments, device 402 may have specific preset modes, such as a vehicle mode, a sleep mode, a low power mode, a specific location mode, etc.

If device 402 is not in a registered mode corresponding to the registered location (N at S806), then method 800 continues until it is determined that device 402 is in the corresponding registered mode (Y at S804).

After determining that the current mode is the corresponding registered mode (Y at S806), a new signature is generated (S808). Consider, for example, the situation where device 402 is located near driver seat 104 and is operating in a vehicle mode, which in this example is associated with the location of driver seat 104. In accordance with aspects of the present invention, device 402 may detect parameters associated with previously registered types of unapproved driving. These detected parameters are used to generate new driving signatures.

For example, the orientation of device 402 may be detected in conjunction with acceleration associated with pushing button on the GUI, this indicating texting. In another example, a speaker may be detected as being activated by analyzing acceleration patterns detected by the accelerometer in the phone. More particularly, using the phone speaker causes a recognizable acceleration pattern typical to such use and by comparing real time accelerometer data to a single or multiple prerecorded driving signatures.

In another non-limiting example embodiment, when device 402 is located near driver seat 104 and is operating in a vehicle mode, device 402 may determine whether the driver is holding the phone up to her ear, thus suggesting that the user is talking while driving. More specifically, a gyroscope within device 402 may be used to identify the orientation of the phone that is unique to a user holding the phone next to her ear.

In another non-limiting example embodiment, when device 402 is located near driver seat 104 and is operating in a vehicle mode, device 402 may monitor light, or a change in light, via a light sensor on device 402 to identify when a user holding the phone next to her ear. If device 402 is positioned proximate a user's head, then the light sensor will read diminished levels of light present.

In another non-limiting example embodiment, when device 402 is located near driver seat 104 and is operating in a vehicle mode, device 402 may detect acceleration. For example, the act of raising device 402 from, for example, the console in a vehicle to the ear will present specific characteristics which may be detected by an accelerometer within device 402.

By analyzing at least one detected parameter associated with device 402, it may be determined whether or not device 402 performing a type of unapproved driving.

When device 402 is in a registered location and is operating in a registered mode corresponding to the registered location and a specific type of unapproved driving is detected, an unapproved driving signal is generated. For example, once it is detected that device 402 is device 402 is located near driver seat 104 and is operating in a vehicle mode and parameters are detected which correspond to talking on device 402, device 402 may generate an unapproved driving signal—which in this case is indicative of talking on device 402 while driving.

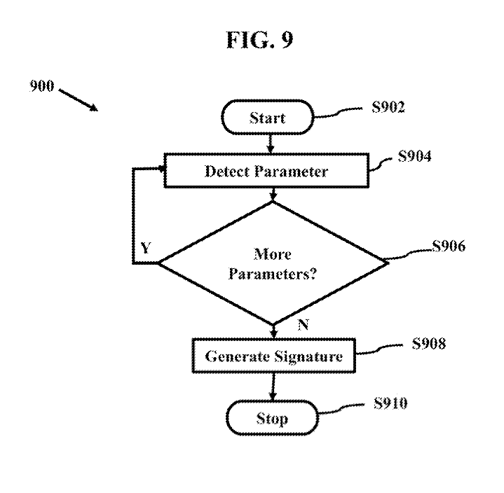

This aspect of the present invention will be further described with reference to FIG. 9.

FIG. 9 illustrates an example method 900 of generating a signature associated with unapproved driving in accordance with aspects of the present invention.

As shown in the figure, method 900 starts (S902) and a parameter is detected (S904). A parameter may be detected by any known method or system. In an example embodiment, a parameter is detected in a manner similar to that discussed above with reference to method 500, e.g., S512. Non-limiting examples of detected parameters include at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

Returning to FIG. 9, after the parameter has been detected (S904), it is determined whether more parameters are to be detected (S906). The additional parameters may be detected by any known method or system. In an example embodiment, additional parameters may be detected in a manner similar to that discussed above with reference to method 500. e.g., S514.

Returning to FIG. 9, if another parameter is to be detected (Y at S906), then another parameter will be detected (S904). This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive type of unapproved driving determination.

A driving signature is then generated (S908). The driving signature may be generated by any known method or system. In an example embodiment, a signature is generated a manner similar to that discussed above with reference to method 500, e.g., S516.

Returning to FIG. 9, after the driving signature is generated (S908), it is then inputted (S910). As shown in FIG. 4, this second signature is provided to comparing component 418.

Method 900 then stops (S910). Returning to FIG. 8, method 800 additionally stops (S810)

Returning to FIG. 3, after the type of unapproved driving has been detected (S306), it is verified (S308). For example, a device in accordance with aspects of the present invention would determine whether the newly detected type of unapproved driving is the type of unapproved driving that was previously registered. A more detailed discussion of registration will now be provided with additional reference to FIG. 10.

FIG. 10 illustrates an example method 1000 of verifying a type of unapproved driving in accordance with aspects of the present invention.

Method 1000 starts (S1002) and the previously stored driving signature is accessed (S1004). For example, as shown in FIG. 4, access component 416 retrieves the previously-stored driving signature from database 404 via communication line 454. Access component 416 then provides the retrieved, previously-stored driving signature to comparator 418 via communication line 456.

Returning to FIG. 7, now that the previously stored driving signature has been accessed (S1004), the driving signatures are compared (S1006). For example, as shown in FIG. 4, comparator 418 compares the retrieved, previously stored driving signature as provided by access component 416 with the newly generated driving signature as provided by field-detecting component 412.

Returning to FIG. 10, now that the driving signatures have been compared (S1006), the type of unapproved driving may be identified and a warning is generated (S1008). For example, as shown in FIG. 4, comparator 418 provides an output to identifying component 420 via communication line 458. If the retrieved, previously stored driving signature as provided by access component 416 matches the newly generated driving signature as provided by field-detecting component 412, then the newly detected type of unapproved driving is the same type of unapproved driving that was previously registered. In such a case, identifying component 420 may indicate that the newly detected type of unapproved driving is the same type of unapproved driving that was previously registered. If the retrieved, previously stored driving signature as provided by access component 416 does not match the newly generated driving signature as provided by field-detecting component 412, then the newly detected type of unapproved driving is not the same type of unapproved driving that was previously registered. In such a case, identifying component 420 may indicate that the newly detected type of unapproved driving is not the same type of unapproved driving that was previously registered.

Once identified, a warning of the unapproved driving is generated. For example, controlling component 428 may instruct communication component 424 to send an unapproved driving signal. As discussed above with reference to FIG. 2B, unapproved driving signal 230 is transmitted from the communication device of driver 214 to dispatcher 204.

Returning to FIG. 6, contact storage component 608 may have contact information stored therein. For example, with reference to FIG. 2B, the communication device of driver 214 may list contact information for dispatcher 204 and person 220. Further, the contact information may additionally include instructions at to what type of unapproved driving signal may be generated for each contact listing. The contact information may be input into contact storage component 608 by any known method or system, a non-limiting example of which includes input component 414.

An unapproved driving signal may take any known form, non-limiting examples of which include a phone call and a text message. An unapproved driving signal may have any known amount of information required to inform of an unapproved driving method, non-limiting examples of which include detailing a specific type of unapproved driving or merely indicating generically unapproved driving.

In other embodiments, returning to FIG. 4, controlling component 428 may instruct the GUI or speaker to generate a warning to the user based on the generated unapproved driving signal. As discussed above with reference to FIG. 2B, the communication device of driver 214 may generate a loud alarm indicating unapproved driving.

At this point, method 1000 stops (S1010).

Returning to FIG. 3, after the type of unapproved driving has been verified, the data is updated (S310). For example, in some embodiments, as shown in FIG. 4, comparator 418 may determine that the previously stored driving signature as provided by access component 416 does not exactly match the newly generated driving signature as provided by field-detecting component 412, but the difference between the previously stored driving signature as provided by access component 416 does not exactly match the newly generated driving signature as provided by field-detecting component 412 is within a predetermined acceptable limit. In such cases, identifying component 420 may indicate that the newly detected type of unapproved driving is still the same type of unapproved driving that was previously registered. Further, comparator 418 may provide the newly generated driving signature as provided by field-detecting component 412 to access component 416 via communication line 456. Access component 416 may then provide the newly generated driving signature to database 404 via communication line 454.

In this manner, database 404 may be “taught” to accept variations of previously registered driving signatures. In some embodiments, an average of recognized driving signatures may be stored for future use. In some embodiments, a plurality of each recognized driving signature may be stored for future use.

Returning to FIG. 3, after updating (S310) device 402 waits to detect a new type of unapproved driving (S306) and method 300 continues.

The example embodiments discussed above are drawn to identifying, via a communication device, an unapproved driving methods using fields and other parameters associated therewith. Once identified, warnings are generated. For example, consider the situation wherein a communication device in accordance with aspects of the present invention is embodied in a smartphone. In such an example, once unapproved driving is identified, the smartphone may warn the user of the device or others that the driving is driving in an unapproved manner.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A device, for use with a database having stored therein, a plurality of signatures corresponding to a plurality of instances, respectively, said device comprising:
a vehicle mode determining component operable to determine whether the device is operating in a vehicle mode;
a device location determining component operable to determine whether the device is located in a predetermined location;
a parameter detecting component operable to detect a predetermined parameter and to generate a parameter signature based on the detected predetermined parameter;
an accessing component operable to access one of the plurality of signatures from the database;
a comparing component operable to generate a comparison signal based on a comparison of the parameter signature and one of the plurality of signatures; and
an unapproved driving component operable to generate an unapproved driving signal based on the comparison signal when said vehicle mode determining component determines that the device is operating in the vehicle mode and when said location determining component determines that the device is located in the predetermined location.

2. The device of claim 1, further comprising:
a timing component operable to have a time threshold stored therein,
wherein said parameter detecting component is operable to detect the predetermined parameter at a first time and a second time,
wherein said parameter detecting component is operable to generate the parameter signature when the difference between the first time and the second time is less than the time threshold.

3. The device of claim 2, wherein said parameter detecting component comprises a detecting component operable to detect at least one of magnetic fields, electric fields, electro-magnetic fields, velocity, acceleration, angular velocity, angular acceleration, geodetic position, sound, temperature, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

4. The device of claim 3, further comprising:
a contact storage component having contact information stored therein; and
a transmitting component operable to transmit a warning signal, based on the unapproved driving signal, to a device associated with the contact information.

5. The device of claim 1, wherein said parameter detecting component is further operable to provide the parameter signature to the database.

6. The device of claim 1, wherein said parameter detecting component operable to detect a second predetermined parameter and to generate the parameter signature based on the detected predetermined parameter and the detected second predetermined parameter.

7. The device of claim 1, further comprising:
a contact storage component having contact information stored therein; and
a transmitting component operable to transmit a warning signal, based on the unapproved driving signal, to a device associated with the contact information.

8. A method of using a database having stored therein, a plurality of signatures corresponding to a plurality of instances, respectively, said method comprising:
determining, via a vehicle mode determining component, whether the device is operating in a vehicle mode;
determining, via a device location determining component, whether the device is located in a predetermined location;
detecting, via a parameter detecting component, a predetermined parameter;
generating, via the parameter detecting component, a parameter signature based on the detected predetermined parameter;
accessing, via an accessing component, one of the plurality of signatures from the database;
generating, via a comparing component, a comparison signal based on a comparison of the parameter signature and one of the plurality of signatures; and
generating, via an unapproved driving component, an unapproved driving signal based on the comparison signal when the vehicle mode determining component determines that the device is operating in the vehicle mode and when the location determining component determines that the device is located in the predetermined location.

9. The method of claim 8, further comprising:
storing a time threshold in a timing component,
wherein said detecting the predetermined parameter comprises detecting the predetermined parameter at a first time and a second time, and
wherein said generating the parameter signature comprises generating the parameter signature when the difference between the first time and the second time is less than the time threshold.

10. The method of claim 9, wherein said detecting, as the predetermined parameter, the user performing at least one of creating the outgoing text and accessing the received text via the texting component comprises detecting at least one of magnetic fields, electric fields, electro-magnetic fields, velocity, acceleration, angular velocity, angular acceleration, geodetic position, sound, temperature, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

11. The method of claim 10, further comprising:
storing contact information in a contact storage component; and
transmitting, via a transmitting component, a warning signal, based on the unapproved driving signal, to a device associated with the contact information.

12. The method of claim 8, further comprising providing, via the parameter detecting component, the parameter signature to the database.

13. The method of claim 8, further comprising:
detecting, via the parameter detecting component, a second predetermined parameter,
wherein said generating the parameter signature comprises generating the parameter signature based on the detected predetermined parameter and the detected second predetermined parameter.

14. The method of claim 8, further comprising:
storing contact information in a contact storage component; and
transmitting, via a transmitting component, a warning signal, based on the unapproved driving signal, to a device associated with the contact information.

15. A non-transitory, tangible, computer-readable media having computer-readable instructions stored thereon, for use with a database having stored therein, a plurality of signatures corresponding to a plurality of instances, respectively, the computer-readable instructions being capable of being read by a computer and being capable of instructing the computer to perform the method comprising:
determining, via a vehicle mode determining component, whether the device is operating in a vehicle mode;
determining, via a device location determining component, whether the device is located in a predetermined location;
detecting, via a parameter detecting component, a predetermined parameter;
generating, via the parameter detecting component, a parameter signature based on the detected predetermined parameter:
accessing, via an accessing component, one of the plurality of signatures from the database;
generating, via a comparing component, a comparison signal based on a comparison of the parameter signature and one of the plurality of signatures; and
generating, via an unapproved driving component, an unapproved driving signal based on the comparison signal when the vehicle mode determining component determines that the device is operating in the vehicle mode and when the location determining component determines that the device is located in the predetermined location.

16. The non-transitory, tangible, computer-readable media of claim 15, the computer-readable instructions being capable of being read by a computer and being capable of instructing the computer to perform the method further comprising:
storing a time threshold in a timing component,
wherein said detecting the predetermined parameter comprises detecting the predetermined parameter at a first time and a second time, and
wherein said generating the parameter signature comprises generating the parameter signature when the difference between the first time and the second time is less than the time threshold.

17. The non-transitory, tangible, computer-readable media of claim 16, wherein the computer-readable instructions are capable of instructing the computer to perform the method such that said detecting, as the predetermined parameter, the user performing at least one of creating the outgoing text and accessing the received text via the texting component comprises detecting at least one of magnetic fields, electric fields, electro-magnetic fields, velocity, acceleration, angular velocity, angular acceleration, geodetic position, sound, temperature, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

18. The non-transitory, tangible, computer-readable media of claim 17, wherein the computer-readable instructions are capable of instructing the computer to perform the method further comprising:
storing contact information in a contact storage component; and
transmitting, via a transmitting component, a warning signal, based on the unapproved driving signal, to a device associated with the contact information.

19. The non-transitory, tangible, computer-readable media of claim 15, the computer-readable instructions being capable of being read by a computer and being capable of instructing the computer to perform the method further comprising providing, via the parameter detecting component, the parameter signature to the database.

20. The non-transitory, tangible, computer-readable media of claim 15, the computer-readable instructions being capable of being read by a computer and being capable of instructing the computer to perform the method further comprising:
detecting, via the parameter detecting component, a second predetermined parameter,
wherein said generating the parameter signature comprises generating the parameter signature based on the detected predetermined parameter and the detected second predetermined parameter.
